(19) United States
(12) Patent Application Publication
(10) Pub. No.: US 2016/0134638 A1
(43) Pub. Date: May 12, 2016

(54) SYSTEMS AND METHODS FOR CONSUMER DIGITAL PRIVILEGES

(71) Applicant: Laudd, Inc., Cupertino, CA (US)

(72) Inventor: Atul Tulshibagwale, Cupertino, CA (US)

(21) Appl. No.: 14/534,570

(22) Filed: Nov. 6, 2014

(51) Int. Cl. H04L 29/06

(52) U.S. Cl. CPC H04L 63/105; H04L 63/102

(57) ABSTRACT

Systems and methods are described for limiting access to digital content based on a privileged access model. In one implementation, a consumer identification is received based on a request by the consumer for content from a first content provider. The content includes a plurality of content portions, with each content portion having an associated minimum privilege level. A privilege level for the consumer is determined, where the privilege level is based at least in part on certain actions of the consumer taken with respect to content previously consumed by the consumer. Content portions can then be provided to the consumer based on the minimum privilege levels of the content portions and the privilege level of the consumer. Additional actions of the consumer can be identified and used to modify the privilege level of the consumer.

### BACKGROUND

The present disclosure relates generally to controlling access to digital content and, more particularly, to systems and methods for associating portions of digital content with respective minimum privilege levels and providing access to the content portions to a consumer based on a privilege level associated with the consumer.

Digital commerce systems typically fall into two broad categories: required payment systems and voluntary payment systems. Required payment systems typically require the consumer to make a payment to directly facilitate a benefit to the payer, such as receiving goods or services. On the other hand, voluntary payment systems typically allow consumers to make a payment that is not directly related to getting a benefit such as goods or services. In voluntary payment systems, there is no direct correlation between the benefit the consumer gets and the payment he has made, though there may be a correlation between the benefit the consumer gets and the collective payments made by a group of consumers. One example of a digital commerce system is a system that enables a digital content provider (such as one providing one or more of news, music, images, videos, interactive features, 3-D printing designs, or similar) to provide content digitally to consumers.

Content providers have various methods of limiting access to content based on payments received through such payment systems. In one example, access to content provided on a website can be restricted using paywalls, where a paid subscription is required to view certain content. Some paywalls allow a consumer to preview or receive a limited amount content prior to obtaining a subscription. For example, newspaper websites often allow readers to view the first few paragraphs of an article or a few articles a month without payment. Such paywalls, however, generally limit access to fundamental portions of content, thereby discouraging content consumption, content discovery on news aggregation portals, and sharing on social media networks.

### BRIEF SUMMARY

Systems and methods for providing access to digital content based on a privileged access model are disclosed herein. In one aspect, a computer-implemented method comprises: receiving an identification of a consumer based on a request by the consumer for content from a first content provider, wherein the content comprises a plurality of content portions, each content portion associated with a respective minimum privilege level; determining, by a computing device having a processor, a privilege level of the consumer, wherein the privilege level is based at least in part on one or more first actions of the consumer taken with respect to content of one or more content providers previously consumed by the consumer; causing one or more of the content portions to be provided to the consumer based on the minimum privilege levels of the content portions and the privilege level of the consumer; identifying one or more second actions of the consumer, wherein the second actions comprise: (a) sharing at least one of the previously consumed content and the provided content portions with one or more other consumers; (b) making a payment to a respective content provider for at least one of the previously consumed content and the provided content portions; (c) making a payment to a content provider without reference to specific content; and (d) consumption of premium content by the consumer; and modifying, by a computing device having a processor, the privilege level of the consumer based on the one or more identified second actions of the consumer. Other embodiments of this aspect include corresponding systems and computer programs.

In one implementation, the requested content comprises webpage content, and a particular content portion comprises at least one of a video, audio, an image, an infographic, text, a game, an application, an interactive feature, and a 3-D printing design. The content portions and the respective minimum privilege levels can be defined using HTML tags.

In another implementation, a first one of the content portions is associated with a lowest privilege level such that the first content portion is provided to all requesting consumers. Content portions that are associated with a minimum privilege level that is not met by the privilege level of the consumer can be obfuscated or blocked from view of the consumer.

In a further implementation, the privilege level of the consumer is based at least in part on one or more first actions of the consumer taken with respect to content of the first content provider, or content of one or more content providers other than the first content provider. The privilege level of the consumer can also be based at least in part on voluntary, suggested, or required payments for content previously made by the consumer to the first content provider. Moreover, the privilege level of the consumer can be based at least in part on voluntary, suggested, or required payments for content previously made by the consumer to content providers other than the first content provider.

In yet another implementation, the first actions comprise: sharing the previously consumed content with one or more other consumers; making a voluntary, suggested, or required payment to one or more of the content providers for the previously consumed content; making a voluntary, suggested, or required payment to one or more of the content providers without reference to specific content; and consumption of content by the consumer.

In one implementation, causing one or more of the content portions to be provided to the consumer comprises identifying one or more of the content portions that each have an associated minimum privilege level that is equal to or less than the privilege level of the consumer.

In another implementation, modifying the privilege level of the consumer based on the one or more identified second actions of the consumer comprises increasing the privilege level if the second action comprises at least one of (a), (b), and (c). Modifying the privilege level of the consumer based on the one or more identified second actions of the consumer can comprise decreasing the privilege level if the second action comprises (d).

In a further implementation, the shared content comprises at least one of content previously viewed by the consumer and content currently being viewed by the consumer. The shared content can also comprise content provided to the consumer by a second, different content provider.

In another implementation, a particular payment made to a content provider can be required, voluntary, or suggested.

In yet another implementation, the method further includes causing additional content to be provided to the consumer if the privilege level of the consumer is less than a threshold privilege level associated with the additional content. The additional content can comprise an advertisement.

In one implementation, the method further includes providing a user interface to the consumer, the user interface comprising a visual display of the privilege level of the consumer and a visual indicator of a title or ranking associated with the consumer, the title or ranking based on the privilege level of the consumer. In another implementation, the method further includes providing a user interface to the consumer, the user interface comprising a list of content items previously provided to the consumer; receiving a selection of one of the content items; and at least one of: causing the selected content item to be shared with one or more other consumers; and receiving a payment for the selected content item.

The details of one or more implementations of the subject matter described in the present specification are set forth in the accompanying drawings and the description below. Other features, aspects, and advantages of the subject matter will become apparent from the description, the drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 is a high-level diagram of communication among a content provider, privilege server, and user device.

FIG. 2 is a flowchart of a method of controlling access to digital content according to an implementation.

FIGS. 3A-3E depict example webpages containing markup for privileged content that may be obfuscated, hidden or shown to users depending upon their privilege levels.

FIGS. 4A-4C are diagrams depicting various implementations of a graphical user interface for sharing content.

FIG. 5 is a diagram depicting an implementation of a graphical user interface for reviewing and sharing content.

FIG. 6 is a high-level diagram of communication among a social network service, privilege server, and user device.

### DETAILED DESCRIPTION

Described herein in various implementations are systems and methods for controlling access to digital content using one or more privilege levels attributed to individual consumers and determined with respect to a particular consumer based on certain actions performed by that consumer, such as sharing content on social networks or making a voluntary or suggested payment for content. The present techniques overcome the various deficiencies associated with existing content restriction systems, such as conventional paywalls, by providing to consumers, in some instances, a standard experience and an enhanced experience, rather than a reduced or denied experience and a standard experience. For example, rather than blocking access to the full text of an article in a web-based newspaper if the consumer does not have a paid subscription, the present system can provide all consumers with the standard, basic article and, instead, only limit access to accompanying premium content such as videos, infographics, and in-depth analyses based on each consumer's privilege level. Further, the system creates incentives for consumers to share content, thereby driving traffic and, as a result, higher advertising revenue to content providers. Moreover, whereas traditional paywalls reset after a period of time to allow a consumer to continue to receive free content without payment, the system disclosed herein allows a consumer to gauge the value of the standard content at all times, giving better insight to the consumer as to whether the premium content is worth obtaining through payment or other means.

“Content,” in some implementations, refers to electronically-provided media, information, or other form of digital matter including, but not limited to, webpages, videos, audio, images, infographics, animations, text, games, applications, interactive features, and 3-D printing designs. For instance, particular content provided to a consumer by a content provider can be a webpage containing a current events article by Newsweek. Particular portions of the webpage content can include individual components such as the article text, accompanying images and infographics, videos, advertisements, in-depth analyses and the like.

A “consumer” or “user” refers to, in some implementations, a person or entity that searches for, accesses, shares, consumes (e.g., reads, views, listens, watches, downloads, etc.), and/or takes other actions with respect to content. For example, a user that reads an article from the New York Times website on his mobile device can be considered a consumer of content (i.e., the article) provided by a content provider (the New York Times).

A “content provider,” in some implementations, refers to a person or entity that creates, offers, provides, and/or digitally distributes content to consumers. In one example, a content provider can provide content via an electronic medium, such as a website. In some implementations, the type, selection, currency (i.e., latest-ness), and/or amount of content provided to a user differs based on the user's privilege level.

“Privilege level” refers to, in some implementations, a quantity representing a user's right or ability to access particular content or certain portions thereof. A privilege level can be binary (e.g., privileged or not privileged, access permitted or access restricted) or can include multiple incremental levels, with each higher level granting the user access to more or better content or certain portions thereof. In some instances, a higher privilege level results in certain content portions being removed or hidden from the user (e.g., intrusive advertisements are automatically hidden or are removed upon the request of a user having a privilege level meeting a threshold). In some implementations, a user's privilege level also has an effect on (a) response speed to requests made by the user, (b) quality of content, layout, fonts, images, videos, etc. that the user sees, (c) presence, number and intrusiveness of advertisements the consumer sees, and/or (d) the selection of content offered to the user. A user's privilege level can have a minimum value (e.g., zero) and/or maximum value (e.g., 100). In instances, there is no minimum or maximum privilege level.

In one example, a user with a first privilege level who accesses a website is permitted access to all basic content, such as text and certain images, but premium content is obfuscated (e.g., blurred, scrambled, etc.), blocked, hidden, or otherwise not shown. In contrast, a user with a second, higher privilege level who views the same website can see the premium content (e.g., infographics and videos not shown to the user with the first privilege level) if he so desires. In some implementations, the privilege level associated with a user applies across all content and content providers (e.g., the user will have the same privilege level across different websites), whereas, in other implementations, the user has a specific privilege level applicable to each content provider or a group of content providers (e.g., the user can potentially have a different privilege level for each supported website he visits based on, for example, the user's actions with respect to content related to a specific topic of interest or geographical location of the user or the user's social connections).

In some implementations, a user's privilege level is point-based or based on another spendable value (e.g., money). In other words, the user's privilege level can correspond to a number of points (or other value) that is associated with the user. In these instances, the user's privilege level can correspond the user's ability to spend value. The user's privilege level can be determined based on actions taken by the user, such as making voluntary or required payments to content providers, purchasing points, sharing content, and/or consuming content. Thus, for example, by purchasing points with money or other consideration, by sharing content, or by making a payment to a content provider, a user can increase his points and, thereby, increase his privilege level (his ability to spend). On the other hand, by requesting access to and/or consuming content not otherwise freely provided, the user's points can be consumed and, accordingly, his privilege level decreased. In one implementation, where the privilege level is binary, as long as the user has at least one point he can be considered as privileged.

In other implementations, a user's privilege level can correspond to an amount or frequency with which the user spends, rather than his capacity to spend. For example, a user can increase or maintain a particular privilege level by sharing content or making voluntary or required payments (in points or other value) a certain number of times or in a minimum amount over a particular period (e.g., minimum of three shares or five points spent a day is required to maintain a current privilege level). In other instances, to increase or maintain a particular privilege level, the user must share content or make payments for each N content consumed (e.g., must share one content item or spend two points for each five content items consumed). In further instances, a user can make voluntary payments totaling a certain amount for content items he consumes in order gain access to a certain number of other content items (e.g., the user can make voluntary payments of $1 for an article he has read in order to gain access to 100 more articles containing premium content).

In other implementations, other actions or events can be tracked by the privilege system and can influence a user's privilege level, such as: (a) an absolute voluntary payment amount made by the user for one or more content pages the user has accessed, (b) a relative payment amount made by the user as compared to payments made by other users, (c) a relative payment amount made by the user as compared to the required payment for particular content, (d) the number of times a user shares content or makes a payment in comparison with the number of times he is provided with content, (e) the total value of the payments made by the consumer either in aggregate of all content providers, for a specific content provider, or for a group of content providers, (f) the average value of the payments by the user for all content providers, a specific content provider, or a group of content providers, (g) the length of time the user has been sharing content or making payments for all content providers, a specific content provider, or a group of content providers, (h) the average amount the user has paid for content similar to content being currently consumed by the user, and/or (i) whether the user has previously shared content similar to content being currently consumed by the user.

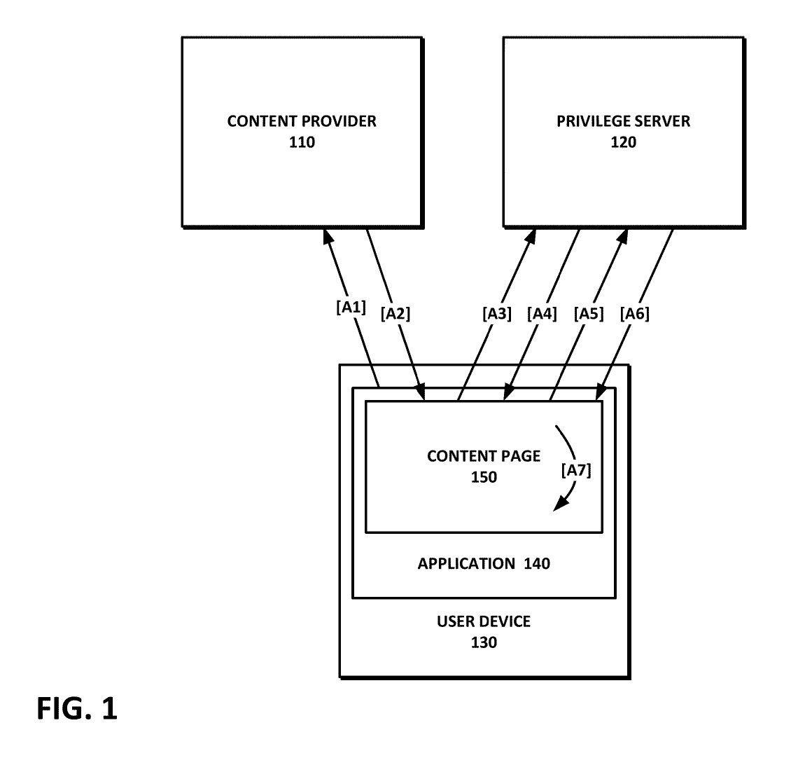

FIG. 1 depicts an example high-level system architecture in which an application 140, such as a web browser, on a user device 130 communicates with one or more content providers 110 and a privilege server 120 over a communications network. Content received by the user device 130 can be displayed to the device user in a window or other area provided by the application 140 (e.g., a browser window). For example, content page 150 can be displayed to the user in a browser window. The user device 130 can be, for example, a smart phone, tablet computer, smart watch, smart glasses, portable computer, mobile telephone, laptop, palmtop, gaming device, music device, television, smart or dumb terminal, network computer, personal digital assistant, wireless device, information appliance, workstation, minicomputer, mainframe computer, or other computing device, that is operated as a general purpose computer or as a special purpose hardware device that can execute the functionality described herein.

Content provider 110 and privilege server 120 can be, for example, server class computers that run a server class operating system (e.g., Oracle® Solaris®, GNU/Linux®, and the Microsoft® Windows® family of operating systems). Content provider 110 can serve as a direct or indirect source of content and can be, for example, a web server, a media server, a file server, a node in a content delivery network (CDN), and the like. The user device, via the application 140, can communicate with the content provider 110 and make requests for content using, for example, Hypertext Transfer Protocol (HTTP) and/or other communications protocols. For example, as shown in FIG. 1, the user can request a content page 150 from content provider 110 using a web browser (STEP A1), and the content provider 110 can transmit the content page 150 to the user device 130 for display in the web browser (STEP A2).

In one implementation, a user privilege system as further described herein is provided via privilege server 120. The application 140 can communicate with the privilege server 120 using HTTP and/or other communications protocols. Information provided by the privilege server 120 can be obtained by the application 140 in conjunction with content provided by the content provider 110. For example, a webpage provided by the content provider 110 can include code (e.g., HTML, JavaScript, etc.) that causes the application 140 to request assets (e.g., media, code, applications) or other information from other third-party sources, such as privilege server 120. Referring to FIG. 1, the content page 150 can include a “<script>” tag that requests JavaScript code from the privilege server 120 (STEP A3). In response, the privilege server 120 can return the JavaScript code to the content page (STEP A4), and the browser can execute the code to create a hidden iframe to facilitate communication with the privilege server 120. In one instance, privilege server 120 provides to application 140 functionality (e.g., a toolbar, widget, etc.) that allows a user to make a payment to the content provider 110 or share content with other users, among other actions. To accomplish this toolbar functionality, the JavaScript code can interpret toolbar tags within the content page 150 and request the toolbar assets from the privilege server 120 through the hidden iframe (STEP A5). Further, in STEP A5, the JavaScript code can also request the user privilege information from the privilege server 120. In response to the request, the privilege server 120 can return the toolbar assets to the application 140 for display on the content page 150 and, if requested, the privilege information (STEP A6).

In one implementation, the content provided to a user is webpage content (which can include text, images, infographics, video, audio, and other assets) with individual portions of the content being defined as premium using tags (e.g., HTML or other code tags) in the webpage source file. For example, a simplified tag defining a premium content portion may be represented as “<div class=“blur” min_privilege=1>”, where the “class” type attribute defines how the content section is to be displayed to a user, and the “min_privilege” attribute represents the minimum privilege level and/or how many points the user must spend to view the content portion. In some implementations, a “max_privilege” attribute can be included in addition to or instead of the “min_privilege” attribute. The “max_privilege” attribute can refer to the maximum privilege level for which the content will be provided (e.g., an advertisement will only be shown to users having no more than the maximum privilege level) and/or how many points the user must spend to view the content portion. In some instances, if no minimum privilege level is specified, the content portion defaults to the lowest possible privilege level. Further if no maximum privilege level is specified, the content portion can default to the highest possible privilege level. “Class” type attributes can include, for example, “blur,” “hide,” “scramble,” “darken,” and other effects to distort or obfuscate the content portion, as well as “show” to display the content portion. The application 140 can execute client-side code (e.g., JavaScript code provided by the privilege server 120) to interpret the tags and implement the obfuscation of any premium content, if necessary (STEP A7). In other instances, the content portions are obfuscated by the content provider 110 and/or the privilege server 120 prior to being provided to the application 140.

The privilege server 120 can be operated by the content provider 110 or a third-party Privilege System Operator (PSO). The PSO can establish relationships with content providers such that the content providers can eventually receive payment or other value for content provided to users. The PSO can require content providers to provide sufficient information to enable the PSO to transfer all or a part of any payment received from users to the content provider's possession. In some implementations, the PSO tracks digital activity, including, but not limited, to conveyance of content, sharing of content, and payments of users who consume content provided by content providers. In one implementation, for users who actually make at least one payment, the PSO establishes a relationship with the user in order to be able to debit points, money, or other value from the user's possession. The PSO can also maintain user accounts, store information identifying a user, and track a user's points and privilege level using functionality provided by the privilege server 120.

In some implementations, a content provider 110 provides certain content to a user without requiring the user to make a payment, share content, or take other action. For example, the content provider 110 can initially provide the user with the text of an article but not the accompanying images. Via functionality provided by the privilege server 120, the content provider 110 can, during or after providing the initial content, offer the user the option to access enhanced or additional (i.e., premium) content portions based on the user's current privilege level. The privilege level required to obtain one or more content portions can be established via functionality provided by the privilege server 120, by the content provider 110 or by the PSO. If the user has a positive privilege level (e.g., more than zero points), the user can “spend” one or more points to obtain the premium content portions. In some instances, a user can obtain all premium content portions relating to the initial content by making a single payment of one or more points. In other cases, the user can individually obtain content portions by making one or more payments of points. The user's privilege level can then decrease in relation to the points spent by the user. The user need not be forced to spend points and can instead consume only the initial content.

If and when a user decides to use his points to obtain premium content portions, the consumer can instruct the privilege server 120 (e.g., via functionality provided by the privilege server 120 and presented to the user through the application 140) to deduct the required number of points (or more than the required number of points, if voluntarily given by the user) from the user's privilege level. The privilege server 120 can then credit all or part of the value of the points to the content provider 110. For example, if the user purchases points for $0.10 each, the content provider 110 can receive $0.07 for each point spent on provided content.

The application 140 can communicate with the privilege server 120 to initiate a user action such as sharing content, spending points, making a monetary payment, and so on. If, for example, the user desires to spend points to access blocked premium content offered by the content provider 110, the user can interact with the blocked content onscreen (e.g., by selecting it, clicking it, tapping it, etc.) or, additionally or alternatively, interact with a toolbar or other control that causes the purchase of the premium content. In other instances, a request can be made automatically on the user's behalf to unblock content. In the foregoing cases, the application 140 can then notify the privilege server 120 of the request, the privilege server 120 ensures the user has a sufficient number of points and, if so, subtracts the points from the user's balance (and, in some implementations, correspondingly decreases the user's privilege level). To unblock the desired premium content, a cross-communication window (e.g., a hidden iframe) can facilitate cross-domain communication between the content (e.g., webpage document) provided by the content provider 110 and the functionality (e.g., toolbar or widget) provided by the privilege server 120. More specifically, via the cross-communication window, the privilege server 120 can direct the application 140 to execute code that unblocks the premium content. In one example, communication between the content webpage and the cross-communication window is facilitated using the AJAX functionality available with HTML5, although other communication techniques are contemplated.

Implementations of the present system and methods can use appropriate hardware or software; for example, the application 140 and other software on user device 130 and/or servers 110, 120 can execute on a system capable of running an operating system such as the Microsoft Windows® operating systems, the Apple OS X® operating systems, the Apple iOS® platform, the Google Android™ platform, the Linux® operating system and other variants of UNIX® operating systems, and the like. The software can be implemented on a general purpose computing device in the form of a computer including a processing unit, a system memory, and a system bus that couples various system components including the system memory to the processing unit. Additionally or alternatively, some or all of the functionality described herein can be performed remotely, in the cloud, or via software-as-a-service.

The present system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application, implemented in a suitable programming language or framework.

Method steps of the techniques described herein can be performed by one or more programmable processors executing one or more computer programs to perform functions by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor receives instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

In some implementations, the user device 130 includes an application 140, such as a web browser, native application, or both, that facilitates execution of the functionality described herein. The application 140 can be implemented in various forms, for example, it can be in the form of a native application, web page, widget, and/or Java, JavaScript, .Net, Silverlight, Flash, and/or other applet or plug-in that is downloaded to the device and runs in conjunction with a web browser. A web browser allows the device to request a web page or other program, applet, document, or resource (e.g., from content provider 110 or other server, such as a web server) with an HTTP request. One example of a web page is a data file that includes computer executable or interpretable information, graphics, sound, text, and/or video, that can be displayed, executed, played, processed, streamed, and/or stored and that can contain links, or pointers, to other web pages. In one implementation, a user of the user device 130 manually requests a resource from a server. Alternatively, the device 130 automatically makes requests with a browser application. Examples of commercially available web browser software include Microsoft® Internet Explorer®, Mozilla® Firefox®, and Apple® Safari®.

A communications network can connect user devices 130 with one or more servers or devices, such as content provider 110 and privilege server 120. The communication can take place over media such as standard telephone lines, LAN or WAN links (e.g., T1, T3, 56 kb, X.25), broadband connections (ISDN, Frame Relay, ATM), wireless links (802.11 (Wi-Fi), Bluetooth, GSM, CDMA, etc.), for example. Other communication media are contemplated. The network can carry TCP/IP protocol communications, and HTTP/HTTPS requests made by a web browser, and the connection between the client device and servers can be communicated over such TCP/IP networks. Other communication protocols are contemplated.

The system can also be practiced in distributed computing environments where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems such as those mentioned above, and that operate on one or more computers having hardware such as that described herein.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

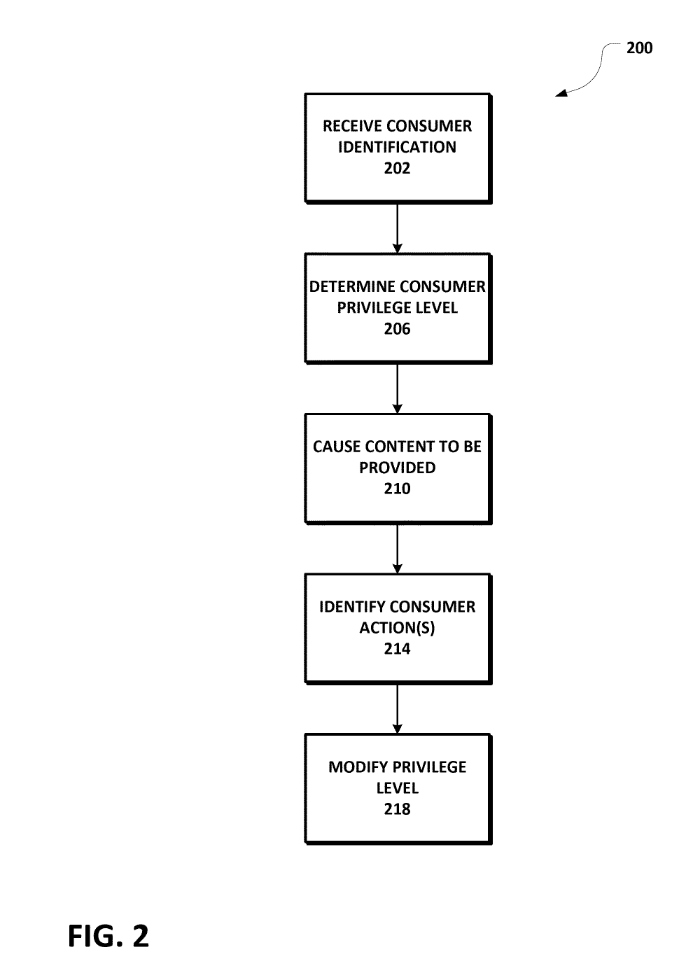

FIG. 2 depicts an example method 200 for facilitating the provision of content to a consumer based on a privileged access model. In STEP 202, the privilege server 120 receives an identification of the consumer based on a request by the consumer for content from the content provider 110. For example, when a consumer requests a webpage through application 140 from the content provider 110, the webpage content can include code that causes the application 140 to communicate with the privilege server 120. As part of this communication, the application 140 can send a consumer identifier to the privilege server 120 (e.g., through a cookie-based or other mechanism). Alternatively, the privilege server 120 can receive information identifying the consumer from the content provider 110 or by using a server-based identification mechanism

In STEP 206, the privilege server 120 determines the privilege level of the consumer. If the consumer is unrecognized (e.g., does not appear to have a user account with the PSO), the consumer can be considered to have no privilege level. In such a case, the consumer can be automatically identified creating a unique identifier for the consumer and setting a cookie in the consumer's browser, or can be prompted to create a new account and, if account creation is successful, the user can be provided with an initial distribution of points free of charge. If, on the other hand, the identification information provided to the privilege server 120 results in positively identifying the consumer, the consumer's privilege level can be determined and communicated to the application 140.

The privilege level can be determined in real-time as needed or by referencing a previously calculated privilege level. In either case, the privilege level can be determined based on various actions previously taken by the consumer with respect to content previously consumed by the consumer. The previously consumed content can have come from the content provider 110 from which the current content is being requested, or from one or more other content providers. The actions previously taken by the consumer can include, but are not limited to: sharing the previously consumed content with one or more other consumers (results in an increase of points or other value available to the consumer); making a monetary payment (or payment in other value) to one or more content providers for the previously consumed content (results in an increase of points or other value available to the consumer in proportion to the amount spent); and consumption of premium content by the consumer (results in a decrease of points available to the consumer corresponding to the value of the content consumed).

Upon determining the privilege level, the privilege server 120 provides the privilege level to the application 140 and the requested content can be displayed for the consumer in accordance with the determined privilege level of the consumer and minimum and/or maximum privilege levels respectively associated with the portions of the content (STEP 210). In some instances, certain content portions are associated with a lowest privilege level and/or highest maximum privilege level, or no privilege level, such that they are provided in a non-obfuscated manner to all consumers, whether or not the consumer has an associated privilege level. For example, a webpage provided to the consumer can include a “standard” experience that includes only text and low-resolution media. With respect to content portions defined as premium by the content provider 110 (and thereby requiring a minimum privilege level), such premium content portions can be automatically displayed to the consumer if the consumer meets the minimum required privilege level. Various content portions can have different required privilege levels such that the consumer may be able to see some and not others in a non-obfuscated fashion. Alternatively, some or all premium content portions can be initially hidden from the consumer, or blocked such that the consumer can see only distorted, blacked-out, blank, or otherwise obfuscated versions of the content portions.

The consumer can then manually select some or all of the premium content portions to unblock (i.e., the consumer can choose to consume specific content portions). Alternatively, the consumer can set his preferences such that all premium content portions associated with a particular content provider (or group of content providers) are automatically unblocked. The user can set preferences for unblocking content on, for example, a global or site-by-site basis. In conjunction with displaying premium content (either automatically or as selected by the consumer), a number of points corresponding to the cost of the premium content (e.g., one point for all premium content) can be deducted from the consumer's points, and, in some implementations, this reduces the consumer's privilege level by a corresponding amount or some other amount. In other implementations, one or more additional content portions are provided to the consumer if his privilege level does not meet a minimum threshold (e.g., is less than a maximum privilege level) or if he chooses not to spend a sufficient number of points. For example, the webpage can include additional, larger, or more intrusive advertisements that can be hidden or made less intrusive if the consumer's privilege level meets the threshold and/or the consumer has spent a specific number of points (on premium content portions viewed prior to the present page). Of note, a consumer's privilege can also be used as an advertising targeting mechanism. For instance, because consumers with higher privilege levels can be considered more likely to spend value on content, ad space intended for advertisements to be viewed by such consumers can be sold at a premium.

The consumer can continue to take actions that affect his privilege level. In STEP 214, the privilege server 120 identifies the occurrence of such actions, which can include: sharing the previously consumed content and/or the currently provided content page with one or more other consumers (results in an increase of points or other value available to the consumer); making a monetary payment to a content provider for the previously consumed content and/or the currently provided content portions (results in an increase of points or other value available to the consumer in proportion to the amount spent); making a monetary payment to a content provider without reference to specific content (results in an increase of points or other value available to the consumer in proportion to the amount spent); and consumption of premium content by the consumer (results in a decrease of points or value available to the consumer in the value of the content consumed). Based on the identified actions, the consumer's privilege level can be modified accordingly (STEP 218).

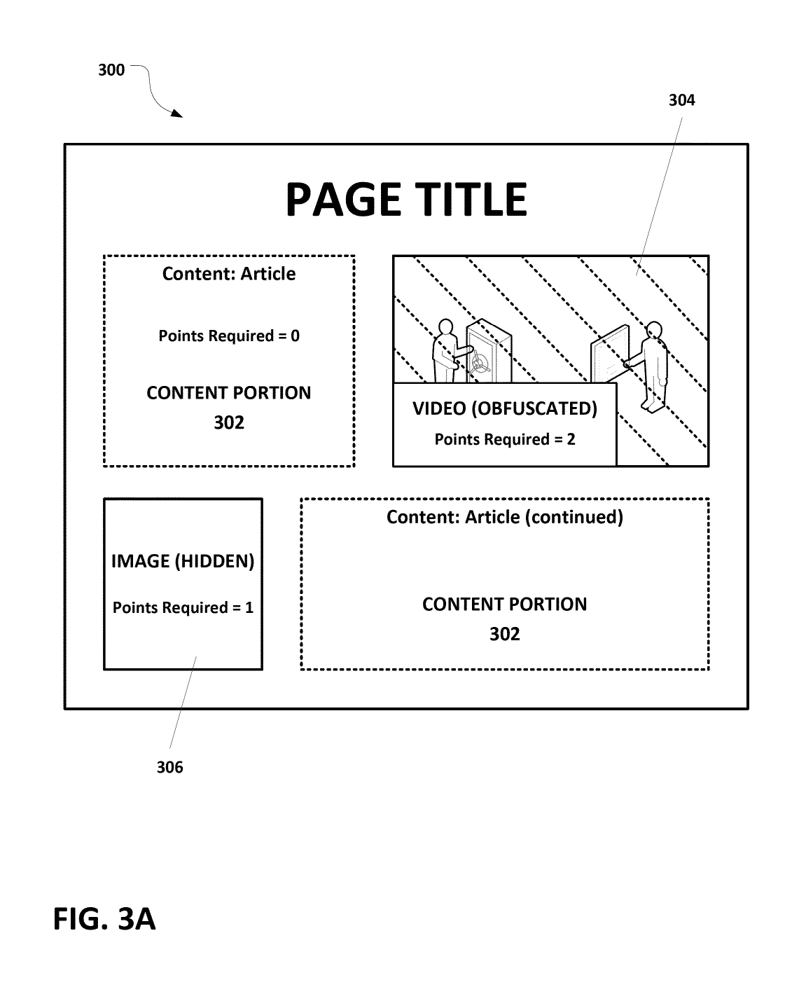

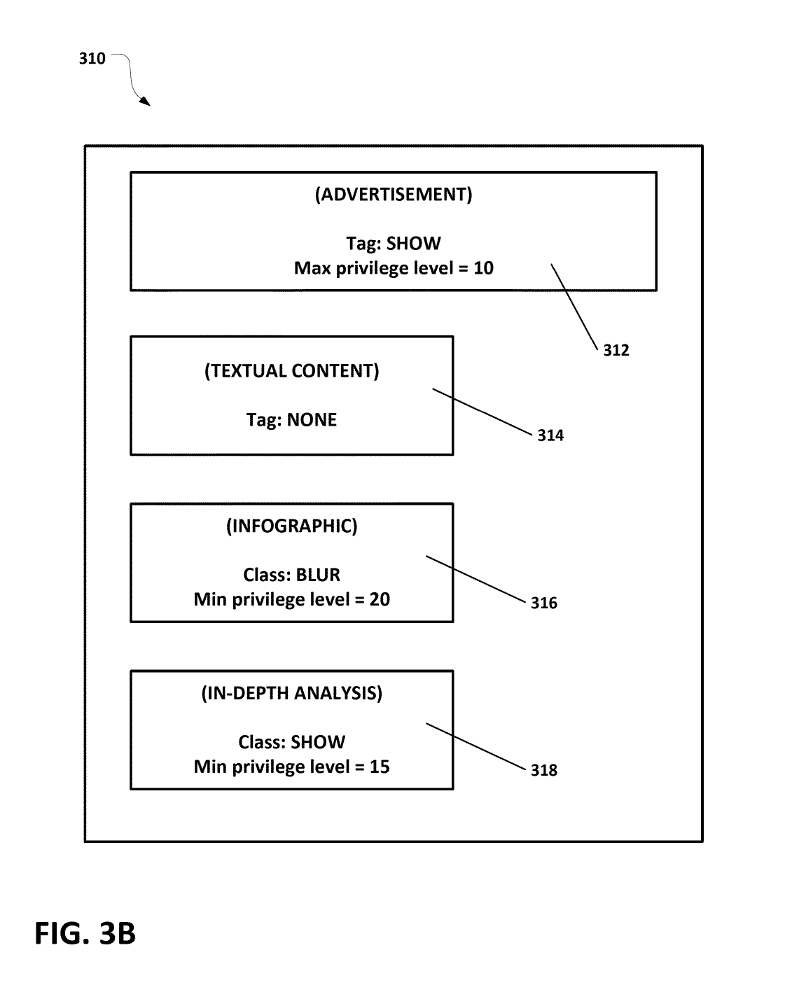

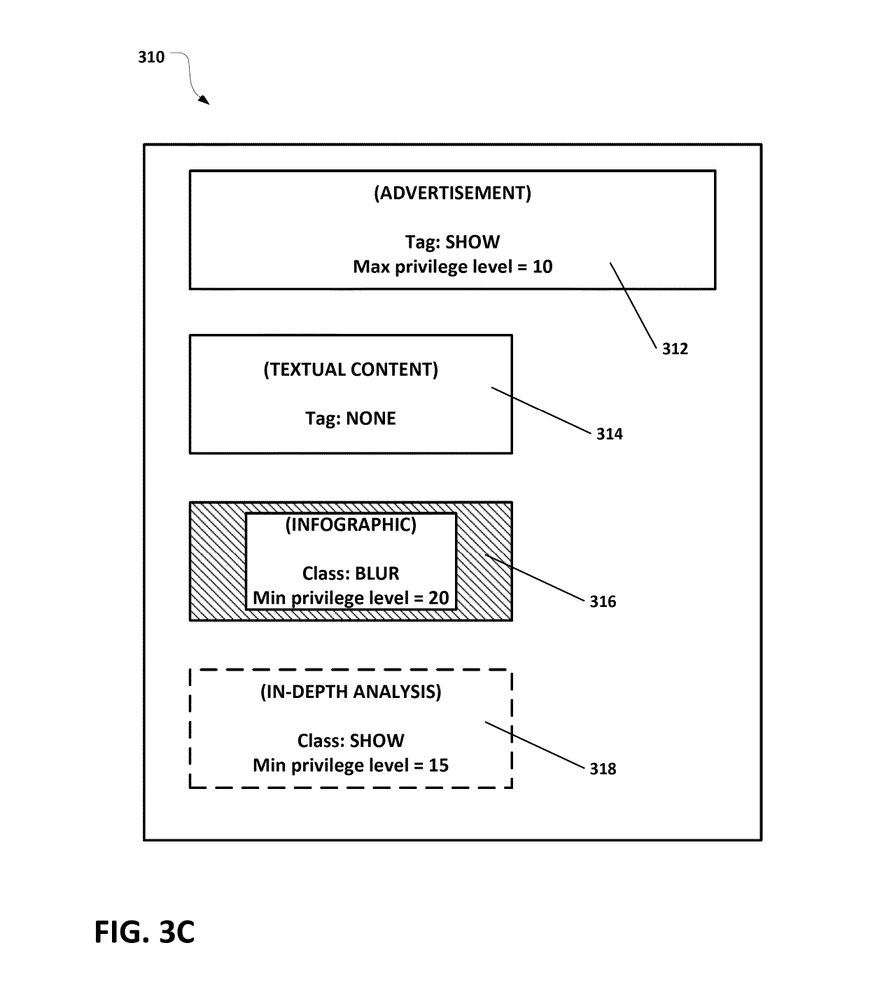

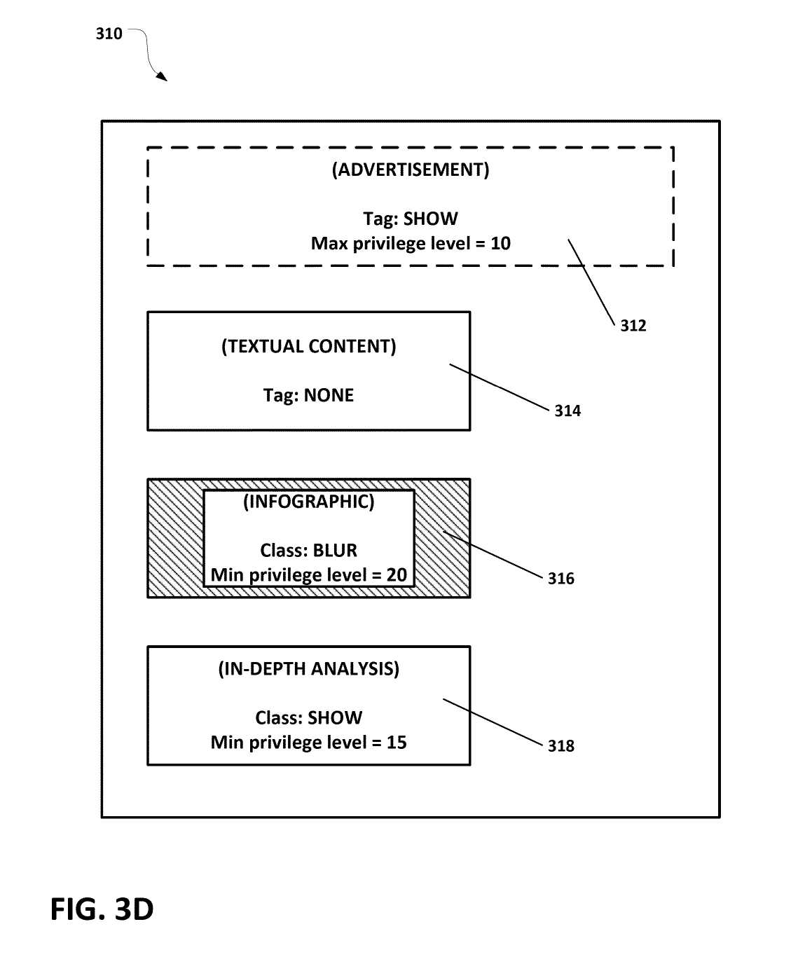

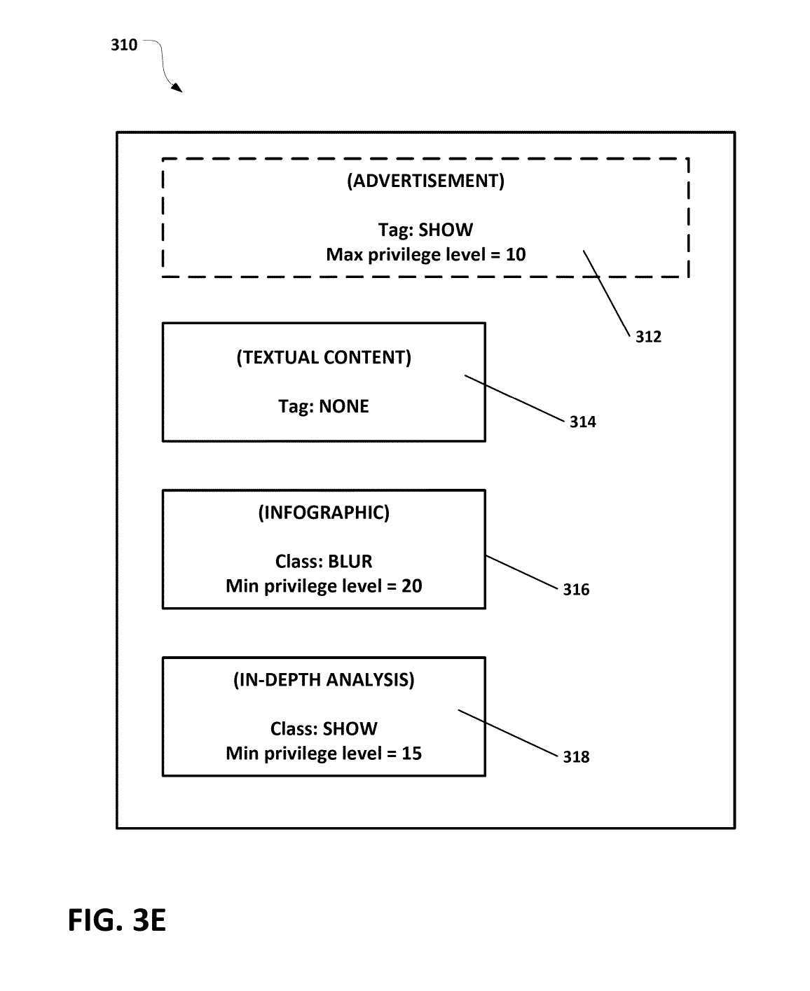

FIG. 3A illustrates one example of webpage content 300 in which individual content portions 302, 304 and 306 are displayed (or not displayed) for a user based on the user's privilege level. In this example, the user has five points to spend (and, in some implementations, the user has a corresponding privilege level of five or other value related to the available points), and only standard content portion 302 (article text) with required points of zero is initially provided to the user. Premium content portions 304 and 306 (image and video, respectively) are initially hidden or obfuscated. It should be noted that the user can, instead, configure his account such that premium content is automatically displayed (and points automatically spent, if necessary). Here, the user can manually select the image and/or the video content portions 304, 306 and spend his points to cause either or both of the content portions 304, 306 to be shown. In some instances, the user must spend a total of three points to display all premium content (two points to display the video content portion 304 and one point display the image content portion 306). In other instances, the user need only spend points corresponding to the required privilege level for the most expensive content in order to unlock all premium content on the page (i.e., spend two points to unlock both the video and image content portions 304, 306).

In another implementation, some or all premium content portions 304, 306 have suggested point requirements, such that point payments are voluntary and the user can unlock the premium content portions 304, 306 for any amount of points, including no points. Whether point payments are required or voluntary, a user can optionally pay more than the required or suggested amount. In further implementations, if the user has historically spent a threshold number of points on content provided by the content provider (or other content providers) over a period of time, some or all of the premium content portions 304, 306 are automatically provided to the user without the need to spend further points. For example, if the user has a privilege level that meets a threshold, a content provider may freely provide the user with some premium content to entice the user to purchase other premium content. In addition to or instead of using points to unlock premium content, other consideration, such as monetary amounts, can be used.

FIG. 3B depicts an example of a webpage 310 with content portions having various associated minimum and/or maximum privilege level requirements, and FIGS. 3C-3E depict the state of the webpage 310 as displayed to users of different respective privilege levels. Referring again to FIG. 3B, content portion 312 includes content (e.g., an advertisement) that is tagged with “SHOW” and has an associated maximum privilege level and, thus, will be shown to users that have a privilege level less than the specified maximum privilege level of 10. No minimum privilege level is specified, and so the lowest possible privilege level (in this case, zero) is assumed. Content portion 314 includes untagged content (e.g., main text) and is unaffected by the privilege system. Content portion 316 includes content (e.g., an infographic) that is tagged with “BLUR” and has an associated minimum privilege level and, thus, will be obfuscated for users that have a privilege level less than the minimum privilege level of 20. No maximum privilege level is specified, and so the highest possible privilege level (in this case, 100) is assumed. For users with a privilege level greater than 20, this content portion 316 can be automatically displayed or requested to be displayed by the user. Content portion 318 includes content (e.g., an in-depth analysis) that is tagged with “SHOW” and has a minimum privilege level and, thus, will be hidden from users with a privilege level less than the minimum privilege level of 15. No maximum privilege level is specified, and so the highest possible privilege level (in this case, 100) is assumed.

FIG. 3C depicts the webpage 310 as seen by a user having an associated privilege level of zero. Because content portion 312 has a maximum privilege level of 10, which is greater than the user's privilege level of zero, the content portion 312 is shown to the user. Content portion 314 is always shown, as it is untagged content. Content portion 316 has a minimum privilege level of 20, which is greater than the user's privilege level of zero, so the content portion 316 remains blurred. Content portion 318 has a minimum privilege level of 15 and is greater than the user's privilege level of zero, so the content portion 318 is hidden from the user.

FIG. 3D depicts the webpage 310 as seen by a user having an associated privilege level of 15. In this case, the user's privilege level exceeds the maximum privilege level of content portion 312 and, thus, the content portion 312 is hidden from the user. Content portion 314 is always shown, as it is untagged content. Content portion 316 has a minimum privilege level of 20, which is greater than the user's privilege level of 15, so the content portion 316 remains blurred. Content portion 318 has a minimum privilege level equal to the user's privilege level of 15, so the content portion 318 is displayed to the user.

FIG. 3E depicts the webpage 310 as seen by a user having an associated privilege level of 25. Again, the user's privilege level exceeds the maximum privilege level of content portion 312 and, thus, the content portion 312 is hidden from the user. Content portion 314 is always shown, as it is untagged content. Now content portion 316 is de-obfuscated and shown to the user, as the user's privilege level of 25 exceeds the minimum privilege level of 20 associated with the content portion 316. Content portion 318 has a minimum privilege level that is exceeded by the user's privilege level of 25, so the content portion 318 is displayed to the user.

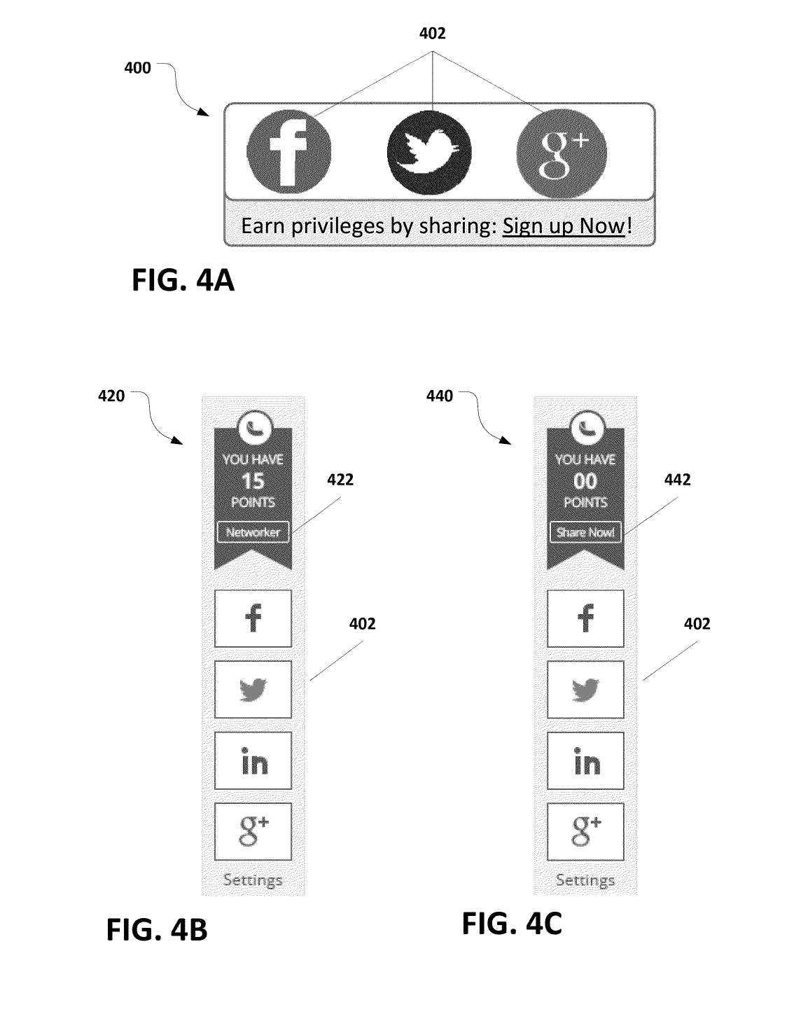

Referring now to FIGS. 4A-4C, in various implementations the privilege server 120 provides and/or controls the operation of a toolbar, widget or other graphical user interface that can be presented to a user via the application 140 (e.g., on a webpage in a browser application). For example, if a user is not logged in to the privilege system or does not have an account, the user can be shown a standard toolbar 400 that prompts the user to sign up to earn privileges. Once the user is logged in, if the user has a threshold number of points (e.g., more than zero points), the toolbar 420, shown in FIG. 4B, can represent that the user is a privileged user. Additionally, the toolbar 420 can display a title or other ranking for the user based on, for example, the number of points he has, the number of payments and/or shares he has previously made, and/or other factors. In FIG. 4B, the user has fifteen points and a title 422 of “Networker.” On the other hand, if the user spends all of his points, the toolbar 440, shown in FIG. 4C, can display that the user must accumulate points to gain privileged status. The title 442 can also instead display a message encouraging the user to share content. In some implementations, to retain privileged status, a user must spend points as well as accumulate them. For example, the user may need to maintain a minimum ratio of points spent to content consumed (e.g., one point spent for every five items of content consumed) in order to retain privileged status.

The toolbars 400, 420, 440 can also include sharing interface controls 402 (e.g., clickable icons or buttons) that allow a user to share currently or previously viewed content through third-party sharing services such social networking, media sharing, content distribution, and/or other platforms. Third-party sharing services can include, but are not limited to, Google+, Facebook, Twitter, YouTube, WhatsApp, Vine, LinkedIn, Snapchat, Instagram, Flickr, and Reddit. By selecting a particular one of the sharing controls 402, previously or currently viewed content can be instantly shared with a user's friends or connections via an interface with the sharing service associated with the selected control. The interface can be a direct interface between the application 140 and the service or an indirect interface with the privilege server 120 acting as an intermediary. In the case where the application 140 directly interfaces with the sharing service (e.g., as in the case of Google+), the privilege server 120 can be notified when the sharing has been completed.

In some implementations, the toolbar 400, 420, or 440 can be shown without point or privilege indicators and without reference to a privilege system. For instance, the content provider 110 can contract with the PSO to provide the privilege system for the content provider's content, but only for a fixed number of unique users (e.g., unique visitors to a website). If the agreed-upon number of users is exceeded, some or all premium content is made freely available, and the privilege system interface is no longer displayed to the user. Instead, the toolbar 400, 420, or 440 can allow the user to directly share content via the sharing interface controls 402 independently from the privilege system.

Upon successfully sharing content, the user can be rewarded with value. In one implementation, by sharing content, one or more points (e.g., five points) can be added to the user's account. If the user attempts to access premium content on a webpage but does not have enough points, he can choose to share that webpage or previously viewed webpages to unlock the premium content. One or more shares can be required to access the premium content (e.g., if the premium content requires multiple points or if the shares award the user fractions of points). The user can be limited in the number of times that he can share a particular content item. For example, the user can be restricted to sharing a content item once per sharing service. Further, in some implementations, the user will only be provided with value if he shares content on a social media account having a minimum number (e.g., 5, 10, 20 or more) of friends or connections.

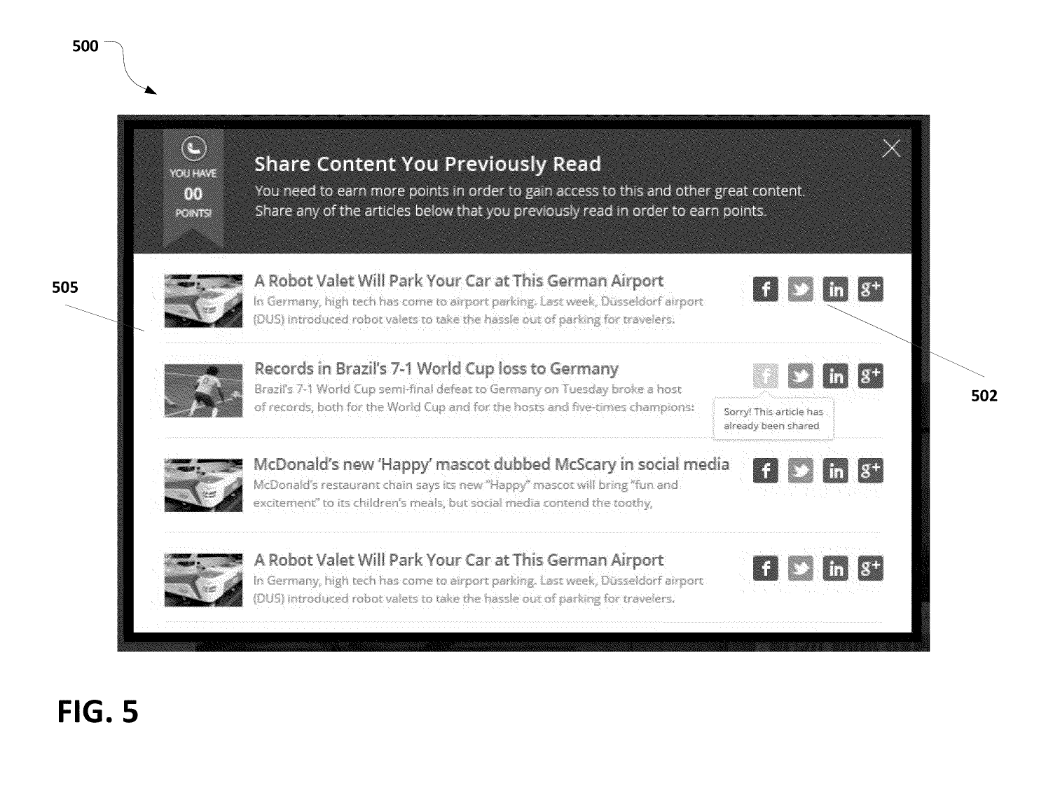

Now referring to FIG. 5, in one implementation, the user can open a reviewing window 500 to share previously viewed content. The reviewing window 500 can be opened upon the user's interaction with the sharing controls 402 on a toolbar 400, 420, 440 or, can be opened upon a user's attempt to unlock premium content for which the user has insufficient privileges. For instance, in FIG. 5, the reviewing window 500 indicates that the user currently has zero points and needs more points to gain access to premium content that the user attempted to unlock. As described herein, the user can obtain points by sharing currently or previously viewed content. The reviewing window 500 provides a list of viewed content 505, with each entry in the list 505 having associated sharing interface controls 502 that allow the user to share the corresponding content using a particular sharing service. As compensation for sharing a particular content item, the user can receive a certain number of points. For example, the user can receive one point for sharing each content item, one point for sharing two content items (i.e., ½ point per content item), or some other value, such as 5 points per share. The user can receive the same point value for each content item shared or, in some cases, certain content items, when shared, can provide the user with different fixed or variable point values.

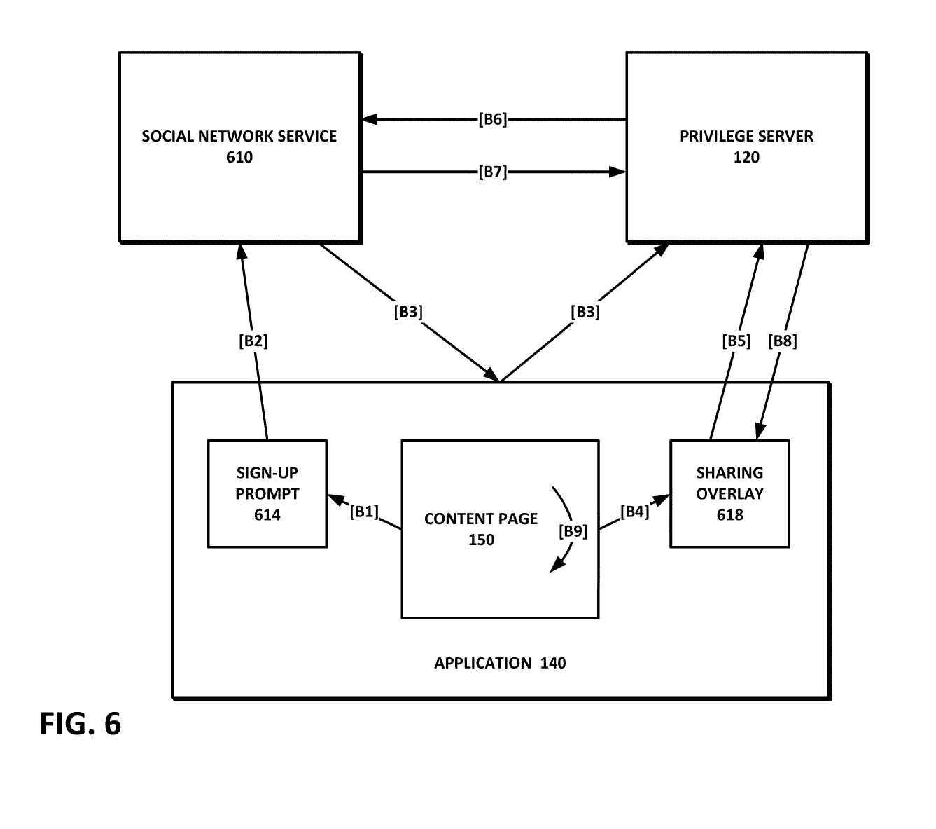

FIG. 6 depicts an example process for privilege service sign-up and server-side sharing. A user can select (e.g., click) one of the sharing icons 402 shown on a toolbar or other interface provided by the privilege system on or overlaying the content page 150. If the user does not already have an account with or is signed out of the selected social network, functionality associated with the content page 150 (e.g., JavaScript code provided by the privilege system) can cause a “Sign Up/Sign In” overlay window 614 to be displayed, which prompts the user to create an account with or sign into the social network (STEP B1). If the user then interacts with the sign up or login controls of the social network, the user is navigated to the social network service 610 to create an account or sign into an existing account (STEP B2). After a successful account creation or login, the social network service 610 redirects the user to the privilege server 120, which can record the user's successful login or sign up (STEP B3).

Upon a successful sign up or login, or if the user is already logged in to the selected social service, the user is shown a sharing prompt overlay 618 (STEP B4). The sharing prompt overlay 618 can be generated using, for example, JavaScript code provided by the privilege system. The details of the content to be shared (e.g., content page 150 or other previously viewed content) along with optional comments from the user are communicated to the privilege server 120 for sharing on the chosen social network service 610 (STEP B5). The privilege server 120 then posts the content details and the user comments, if any, to the social network service 610 on behalf of the user (STEP B6). Upon receiving an indication from the social network service 610 that the share was successful (STEP B7), the privilege server 120 responds to the communication made in STEP B5 with the user's new points status (e.g., the user's new point total, including points received from sharing the content) (STEP B8). Based on the user's new points status, functionality (e.g., JavaScript code) on the content page 150 provided by the privilege system can unhide or otherwise de-obfuscate content portions on the page 150 as appropriate (e.g., all premium content portions, selected premium content portions, premium content portions associated with a minimum privilege level that the user now meets, etc.), and can update the toolbar or other interface to reflect the user's point value, title, and/or other status (STEP B9).

The terms and expressions employed herein are used as terms and expressions of description and not of limitation, and there is no intention, in the use of such terms and expressions, of excluding any equivalents of the features shown and described or portions thereof. In addition, having described certain implementations in the present disclosure, it will be apparent to those of ordinary skill in the art that other implementations incorporating the concepts disclosed herein can be used without departing from the spirit and scope of the invention. The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method comprising:
receiving an identification of a consumer based on a request by the consumer for content from a first content provider, wherein the content comprises a plurality of content portions, each content portion associated with a respective minimum privilege level;
determining, by a computing device having a processor, a privilege level of the consumer, wherein the privilege level is based at least in part on one or more first actions of the consumer taken with respect to content of one or more content providers previously consumed by the consumer;
causing one or more of the content portions to be provided to the consumer based on the minimum privilege levels of the content portions and the privilege level of the consumer;
identifying one or more second actions of the consumer, wherein the second actions comprise:
(a) sharing at least one of the previously consumed content and the provided content portions with one or more other consumers;
(b) making a payment to a respective content provider for at least one of the previously consumed content and the provided content portions;
(c) making a payment to a content provider without reference to specific content; and
(d) consumption of premium content by the consumer; and
modifying, by a computing device having a processor, the privilege level of the consumer based on the one or more identified second actions of the consumer.

2. The method of claim 1, wherein the requested content comprises webpage content, and wherein a particular content portion comprises at least one of a video, audio, an image, an infographic, text, a game, an application, an interactive feature, and a 3-D printing design.

3. The method of claim 2, wherein the content portions and the respective minimum privilege levels are defined using HTML tags.

4. The method of claim 1, wherein a first one of the content portions is associated with a lowest privilege level such that the first content portion is provided to all requesting consumers.

5. The method of claim 1, wherein content portions that are associated with a minimum privilege level that is not met by the privilege level of the consumer are obfuscated or blocked from view of the consumer.

6. The method of claim 1, wherein the privilege level of the consumer is based at least in part on one or more first actions of the consumer taken with respect to the first content provider.

7. The method of claim 1, wherein the privilege level of the consumer is based at least in part on one or more first actions of the consumer taken with respect to content of one or more content providers other than the first content provider.

8. The method of claim 1, wherein the privilege level of the consumer is based at least in part on voluntary, suggested or required payments for content previously made by the consumer to the first content provider.

9. The method of claim 1, wherein the privilege level of the consumer is based at least in part on voluntary, suggested or required payments for content previously made by the consumer to content providers other than the first content provider.

10. The method of claim 1, wherein the first actions comprise:
sharing the previously consumed content with one or more other consumers;
making a voluntary, suggested or required payment to one or more of the content providers for the previously consumed content;
making a voluntary, suggested or required payment to one or more of the content providers without reference to specific content; and
consumption of content by the consumer.

11. The method of claim 1, wherein causing one or more of the content portions to be provided to the consumer comprises identifying one or more of the content portions that each have an associated minimum privilege level that is less than or equal to the privilege level of the consumer.

12. The method of claim 1, wherein modifying the privilege level of the consumer based on the one or more identified second actions of the consumer comprises increasing the privilege level if the second action comprises at least one of (a), (b), and (c).

13. The method of claim 1, wherein modifying the privilege level of the consumer based on the one or more identified second actions of the consumer comprises decreasing the privilege level if the second action comprises (d).

14. The method of claim 1, wherein the shared content comprises at least one of content previously viewed by the consumer and content currently being viewed by the consumer.

15. The method of claim 1, wherein the shared content comprises content provided to the consumer by a second, different content provider.

16. The method of claim 1, wherein a particular payment made to a content provider is required, voluntary, or suggested.

17. The method of claim 1, further comprising causing additional content to be provided to the consumer if the privilege level of the consumer is less than a threshold privilege level associated with the additional content.

18. The method of claim 17, wherein the additional content comprises an advertisement.

19. The method of claim 1, further comprising providing a user interface to the consumer, the user interface comprising:
a visual display of the privilege level of the consumer; and
a visual indicator of a title or ranking associated with the consumer, the title or ranking based on the privilege level of the consumer.

20. The method of claim 1, further comprising:
providing a user interface to the consumer, the user interface comprising a list of content items previously provided to the consumer;
receiving a selection of one of the content items; and
at least one of:
causing the selected content item to be shared with one or more other consumers; and
receiving a payment for the selected content item.

21. A system comprising:
one or more computers programmed to perform operations comprising:
receiving an identification of a consumer based on a request by the consumer for content from a first content provider, wherein the content comprises a plurality of content portions, each content portion associated with a respective minimum privilege level;
determining, by a computing device having a processor, a privilege level of the consumer, wherein the privilege level is based at least in part on one or more first actions of the consumer taken with respect to content of one or more content providers previously consumed by the consumer;
causing one or more of the content portions to be provided to the consumer based on the minimum privilege levels of the content portions and the privilege level of the consumer;
identifying one or more second actions of the consumer, wherein the second actions comprise:
(a) sharing at least one of the previously consumed content and the provided content portions with one or more other consumers;
(b) making a payment to a respective content provider for at least one of the previously consumed content and the provided content portions;
(c) making a payment to a content provider without reference to specific content; and
(d) consumption of premium content by the consumer; and
modifying, by a computing device having a processor, the privilege level of the consumer based on the one or more identified second actions.

22. The system of claim 21, wherein the requested content comprises webpage content, and wherein a particular content portion comprises at least one of a video, audio, an image, an infographic, text, a game, and application, an interactive feature, and a 3-D printing design.

23. The system of claim 22, wherein the content portions and the respective minimum privilege levels are defined using HTML tags.

24. The system of claim 21, wherein a first one of the content portions is associated with a lowest privilege level such that the first content portion is provided to all requesting consumers.

25. The system of claim 21, wherein content portions that are associated with a minimum privilege level that is not met by the privilege level of the consumer are obfuscated or blocked from view of the consumer.

26. The system of claim 21, wherein the privilege level of the consumer is based at least in part on one or more first actions of the consumer taken with respect to the first content provider.

27. The system of claim 21, wherein the privilege level of the consumer is based at least in part on one or more first actions of the consumer taken with respect to content of one or more content providers other than the first content provider.

28. The system of claim 21, wherein the privilege level of the consumer is based at least in part on voluntary, suggested, or required payments for content previously made by the consumer to the first content provider.

29. The system of claim 21, wherein the privilege level of the consumer is based at least in part on voluntary, suggested, or required payments for content previously made by the consumer to content providers other than the first content provider.

30. The system of claim 21, wherein the first actions comprise:
sharing the previously consumed content with one or more other consumers;
making a voluntary, suggested, or required payment to one or more of the content providers for the previously consumed content;
making a voluntary, suggested, or required payment to one or more of the content providers without reference to specific content; and
consumption of content by the consumer.

31. The system of claim 21, wherein causing one or more of the content portions to be provided to the consumer comprises identifying one or more of the content portions that each have an associated minimum privilege level that is less than or equal to the privilege level of the consumer.

32. The system of claim 21, wherein modifying the privilege level of the consumer based on the one or more identified second actions of the consumer comprises increasing the privilege level if the second action comprises (a), (b), (c).

33. The system of claim 21, wherein modifying the privilege level of the consumer based on the one or more identified second actions of the consumer comprises decreasing the privilege level if the second action comprises (d).

34. The system of claim 21, wherein the shared content comprises at least one of content previously viewed by the consumer and content currently being viewed by the consumer.

35. The system of claim 21, wherein the shared content comprises content provided to the consumer by a second, different content provider.

36. The system of claim 21, wherein a particular payment made to a content provider is required, voluntary, or suggested.

37. The system of claim 21, wherein the operations further comprise causing additional content to be provided to the consumer if the privilege level of the consumer is less than a threshold privilege level associated with the additional content.

38. The system of claim 37, wherein the additional content comprises an advertisement.

39. The system of claim 21, further comprising providing a user interface to the consumer, the user interface comprising:
a visual display of the privilege level of the consumer; and
a visual indicator of a title or ranking associated with the consumer, the title or ranking based on the privilege level of the consumer.

40. The system of claim 21, wherein the operations further comprise:
providing a user interface to the consumer, the user interface comprising a list of content items previously provided to the consumer;
receiving a selection of one of the content items; and
at least one of:
causing the selected content item to be shared with one or more other consumers; and
receiving a payment for the selected content item.
